(19) United States
(12) Patent Application Publication
(10) Pub. No.: US 2014/0337202 A1
(43) Pub. Date: Nov. 13, 2014

(54) Guaranty Fund Apportionment in Default Auctions

(71) Applicant: Chicago Mercantile Exchange Inc., Chicago, IL (US)

(72) Inventors: Marco Ossanna, Chicago, IL (US); Jason Silverstein, Chicago, IL (US); Gautam Gururaj, Chicago, IL (US); Corey Farabi, Chicago, IL (US); Udesh Jha, Chicago, IL (US)

(21) Appl. No.: 14/340,728

(22) Filed: Jul. 25, 2014

Related U.S. Application Data
(63) Continuation of application No. 13/558,121, filed on Jul. 25, 2012.

(51) Int. Cl. G06Q 40/04

(52) U.S. Cl. CPC G06Q 40/04
USPC 705/37

(57) ABSTRACT

A method apportions guaranty fund contributions into tranches in connection with an auction directed to transferring open positions in a set of markets, such as positions in interest rate swap contracts. Bids for the open positions from non-default market participants are received. A quality factor is determined for each bid based on an offset between the bid and a winning bid in the auction for each open position. For each market and for each non-default market participant, a portion of the guaranty fund contribution of the non-default market participant is allocated to one of the tranches based on the quality factor for the market.

### CROSS-REFERENCE TO RELATED APPLICATION

This application is a continuation under 37 C.F.R. §1.53(b) of U.S. patent application Ser. No. 13/558,121, filed Jul. 25, 2012 (Attorney Docket No. 4672/12005A), the entire disclosure of which is hereby incorporated by reference.

### BACKGROUND

A financial instrument trading system, such as a futures exchange, referred to herein also as an “Exchange”, such as the Chicago Mercantile Exchange Inc. (CME), provides a contract market where financial instruments, for example futures and options on futures, are traded. Futures is a term used to designate all contracts for the purchase or sale of financial instruments or physical commodities for future delivery or cash settlement on a commodity futures exchange. A futures contract is a legally binding agreement to buy or sell a commodity at a specified price at a predetermined future time. An option is the right, but not the obligation, to sell or buy the underlying instrument (in this case, a futures contract) at a specified price within a specified time. The commodity to be delivered in fulfillment of the contract, or alternatively the commodity for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement. Cash Settlement is a method of settling a futures contract whereby the parties effect final settlement when the contract expires by paying/receiving the loss/gain related to the contract in cash, rather than by effecting physical sale and purchase of the underlying reference commodity at a price determined by the futures contract, price.

Typically, the Exchange provides for a centralized “clearing house” through which all trades made must be confirmed, matched, and settled each day until offset or delivered. The clearing house is an adjunct to the Exchange, and may be an operating division of the Exchange, which is responsible for settling trading accounts, clearing trades, collecting and maintaining performance bond funds, regulating delivery, and reporting trading data. The essential role of the clearing house is to mitigate credit risk. Clearing is the procedure through which the Clearing House becomes buyer to each seller of a futures contract, and seller to each buyer, also referred to as a novation, and assumes responsibility for protecting buyers and sellers from financial loss due to breach of contract, by assuring performance on each contract. A clearing member is a firm qualified to clear trades through the Clearing House.

An interest rate futures contract, also referred to as an interest rate future, is a futures contract having an underlying instrument/asset that pays interest, for which the parties to the contract are a buyer and a seller agreeing to the future delivery of the interest bearing asset, or a contractually specified substitute. Such a futures contract permits a buyer and seller to lock in the price, or in more general terms the interest rate exposure, of the interest-bearing asset for a future date.

An interest rate swap (“IRS”) is a contractual agreement between two parties, i.e., the counterparties, where one stream of future interest payments is exchanged for another, e.g., a stream of fixed interest rate payments in exchange for a stream of floating interest rate payments, based on a specified principal amount. An IRS may be used to limit or manage exposure to fluctuations in interest rates. One common form of IRS exchanges a stream of floating interest rate payments on the basis of the 3-month London interbank offered rate for a stream of fixed-rate payments on the basis of the swap's fixed interest rate. Another common form of IRS, knows as an overnight index swap, exchanges at its termination a floating rate payment determined by daily compounding of a sequence of floating interest rates on the basis of an overnight interest rate reference (e.g., the US daily effective federal funds rate, or the European Overnight Index Average (EONIA)) over the life of the swap, for a fixed rate payment on the basis of daily compounding of the overnight index swap's fixed interest rate over the life of the swap.

An interest rate swap futures contract is one in which the underlying instrument is an interest rate swap. As such, an interest rate swap futures contract permits “synthetic” exposure to the underlying interest rate swap, i.e., without entailing actual ownership of the underlying IRS.

In a typical futures trading environment, the standardization of futures contracts and the nature of the central counterparty based trading system allows an Exchange, or market participant thereof, to net together offsetting positions in the same contract for the purpose of reducing the margin requirement to reflect the reduced risk of loss of such positions and/or to outright consolidate positions to reduce the size of the portfolio and/or reduce transaction fees therefore. As the Exchange, being a central counterparty to all transactions, ensures that each counter-party is not at risk of loss due to the default of the other party, such netting and consolidation by one market participant does not affect the positions and risk undertaken by another participant.

Despite the use of margin requirements, trading in IRS and IRS futures contracts still presents a risk of loss for the Exchange in the event of a default of one of the clearing firms. To protect against losses from a default, the Exchange typically contractually obligates each clearing firm member to (1) contribute funds to a guaranty fund, and (2) participate in an auction to transfer open positions of the defaulting firm to the non-defaulting firms. The guaranty fund is used to cover any losses remaining after the auction.

The Exchange may attempt to hedge one or more of the open positions of the defaulting firm before the auction is conducted to reduce potential exposure for the Exchange and the clearing firms. Unfortunately, a risk of loss may remain if the exposure created by the open positions cannot be sufficiently hedged or if the subsequent auction is insufficiently competitive.

### BRIEF DESCRIPTION OF THE DRAWINGS

FIG. 1 depicts an illustrative computer network system that may be used to implement aspects of the disclosed embodiments.

FIG. 2 a block diagram of an exemplary implementation of the system of FIG. 1 for apportionment of a guaranty fund in a default auction in accordance with the disclosed embodiments.

FIG. 3 depicts a flow chart showing operation of the system of FIGS. 1 and 2.

FIG. 4 shows an illustrative embodiment of a general computer system for use with the system of FIGS. 1 and 2.

FIG. 5 shows an exemplary implementation of the disclosed embodiments.

### DETAILED DESCRIPTION

The disclosed embodiments relate to systems and methods for default management. The disclosed methods and systems are implemented in connection with an auction of the open positions of a market participant (e.g., clearing firm member) in default. The open positions are transferred via the auction to other market participants to minimize losses to be covered by a guaranty fund to which each market participant contributes funds. The disclosed methods and systems are configured to apportion the contributions of the non-defaulting market participants to one or more tranches for prioritization in accordance with the quality of their bids in the auction. For each winning bid from a market participant, a portion of the guaranty fund contribution for that market participant is allocated to a senior tranche. Non-winning bids may be allocated to a junior tranche based on an offset between the bid and the winning bid. Funds in the senior tranche(s) have a higher priority than funds in the junior tranche(s), such that the funds in the junior tranche(s) are exhausted first. The market participants are thus incentivized to provide aggressive or at least reasonable bids during the auction so as to avoid the subordination of their contributions to the guaranty fund.

The apportionment of the guaranty fund contribution for each market participant may proceed on a market-by-market basis. As described below, the portion of the guaranty fund contribution at risk of penalization (via subordination or juniorization to a lower tranche) or promotion (via superordination or seniorization to a higher tranche) may be defined in accordance with a risk assessment proportion for each market. The risk assessment proportion for each market may be determined by analyzing data indicative of the positions held by the market participant in the market. In some embodiments, the risk assessment proportions are adjusted to reflect an analysis of the exposure in each market presented by the open positions of the market participant in default. The auction participants may thus be further incentivized to provide aggressive or reasonable bids for the open positions in markets in which the potential for losses to the guaranty fund is greatest.

The default management techniques of the disclosed methods and systems may be incorporated into a risk management system of the Exchange. Alternatively or additionally, the disclosed methods and systems may be implemented as part of a default management process to handle the default of any clearing member. The process may include the following stages: (1) hedging the portfolio of the defaulting clearing member according to pre-defined hedging strategies; (2) conducting a competitive auction for the open positions remaining from the portfolio; and (3) applying the guaranty fund to cover the loss produced by the defaulting clearing member and remaining after the auction.

The incentives provided by the disclosed methods and systems may be useful in auctions in which the non-defaulting clearing members are contractually obligated to submit a bid during the auction. Without an incentive to bid, however, the bidding firms may submit intentionally non-competitive bids that only technically satisfy the obligation to participate in the auction.

The disclosed methods and systems are configured to determine the quality of the bids. A quality factor may be determined for each bid based on the offset between the bid and the winning bid. In some embodiments, the quality factor is representative of the non-competitiveness of the bid by indicating an erosion metric, which may be calculated in reference to the winning bid in any given auction as follows: Erosion=|Bidᵢ−Bid_{w}|/IM, where IM is the initial margin of the open position, and Bidᵢ is the bid of one of the non-winning clearing member and Bid_{w} is the winning bid. The initial margin may be determined via a stress test or other historical analysis to determine a worst-case scenario or other loss after application of the posted performance bond.

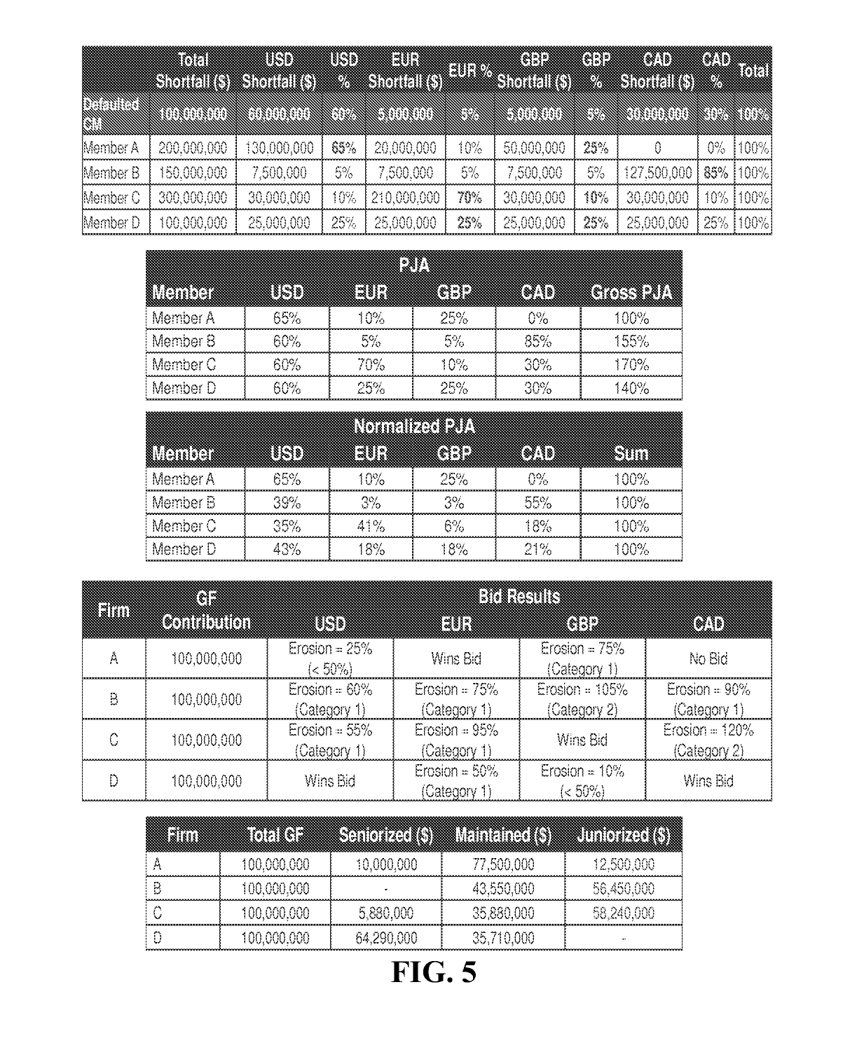

In one embodiment described further below in connection with an example shown in FIG. 5, bids with erosion levels under 50% are considered qualifying and are not penalized. In some example, the corresponding portion of the guaranty fund contribution may thus be allocated to an intermediate tranche between the higher and lower tranches. Bids with erosion levels over 50% are considered to be non-qualifying.

The erosion level or other quality factor may be used to determine the size of the portion to be penalized or rewarded. The penalties may vary linearly with the erosion. For example, erosion levels falling between 50% and 100% may fall into a category in which the portion of the guaranty fund contribution subject to penalty is linearly determined by a weighting factor (e.g., 2*(Erosion−50%)). A second category may correspond with erosion levels above 100%, in which the full portion of the guaranty fund contribution is penalized. There may be any number of categories of non-qualifying bids.

In some embodiments, the disclosed methods and systems are implemented in a centralized processing system, such as one hosted by the Exchange. Alternatively, the disclosed embodiments may implemented in a distributed fashion where a portion of the functionality may be implemented on a computer system of the market participant. For example, a client application may be provided to the market participant, or otherwise integrated with the trading interface utilized thereby, which displays information regarding the auction and otherwise enables the functionality described herein. The client application may then interface or otherwise interact with a back-end system or database of the Exchange to submit bids, execute and view the results of simulated or actual auctions against the other market participants or otherwise exchange data and messages therewith. The disclosed embodiments may be implemented in different ways that provide the disclosed functionality that facilitates the auction process.

As discussed above, an IRS is a contractual agreement between two parties, i.e., the counterparties, where one stream of future interest payments is exchanged for another, e.g., a stream of fixed interest rate payments in exchange for a stream of floating interest rate payments, based on a specified principal amount. An IRS may be used to limit or manage exposure to fluctuations in interest rates. One common form of IRS exchanges a stream of floating interest rate payments on the basis of the 3-month London interbank offered rate for a stream of fixed-rate payments on the basis of the swap's fixed interest rate. Another common form of IRS, knows as an overnight index swap, exchanges at its termination a floating rate payment determined by daily compounding of a sequence of floating interest rates on the basis of an overnight interest rate reference (e.g., the US daily effective federal funds rate, or the European Overnight Index Average (EONIA)) over the life of the swap, for a fixed rate payment on the basis of daily compounding of the overnight index swap's fixed interest rate over the life of the swap.

While the disclosed embodiments may be discussed in relation to IRS contracts and apportionment in multicurrency contexts, it will be appreciated that the disclosed embodiments may be applicable to other bilateral contracts, equity, options or futures trading system or other market now available or later developed.

It will be appreciated that the plurality of entities utilizing the disclosed embodiments, e.g. the market participants, may be referred to by other nomenclature reflecting the role that the particular entity is performing with respect to the disclosed embodiments and that a given entity may perform more than one role depending upon the implementation and the nature of the particular transaction being undertaken, as well as the entity's contractual and/or legal relationship with another market participant and/or the exchange.

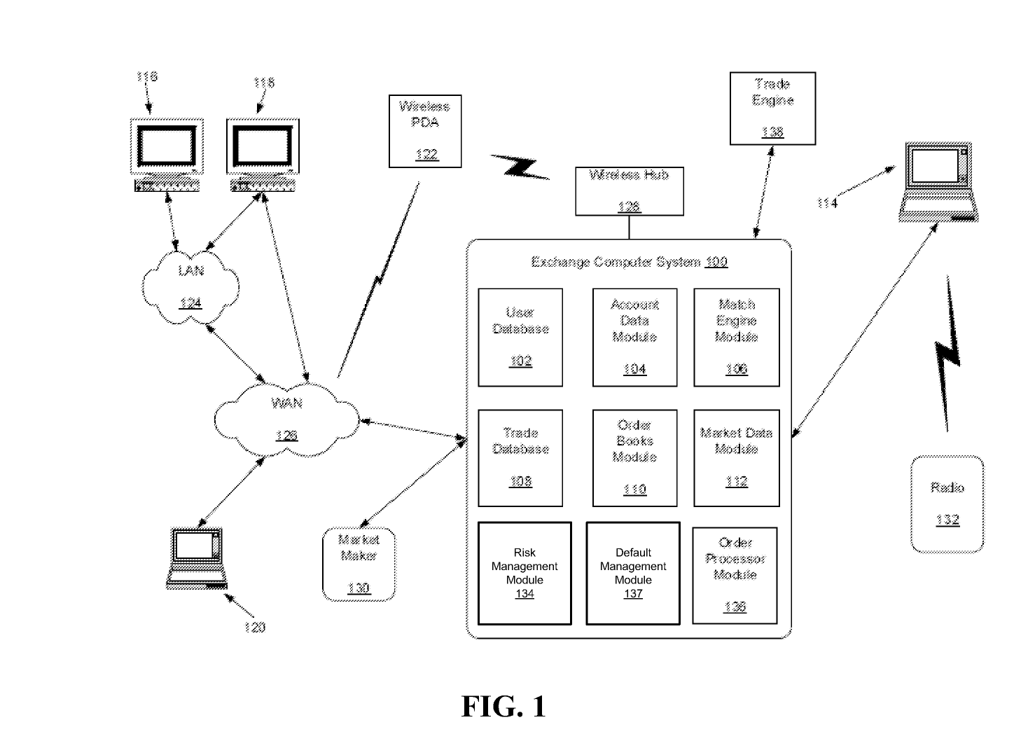

An exemplary trading network environment for implementing trading systems and methods is shown in FIG. 1. An exchange computer system 100 receives orders and transmits market data related to orders and trades to users, such as via wide area network 126 and/or local area network 124 and computer devices 114, 116, 118, 120 and 122, as will be described below, coupled with the exchange computer system 100.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

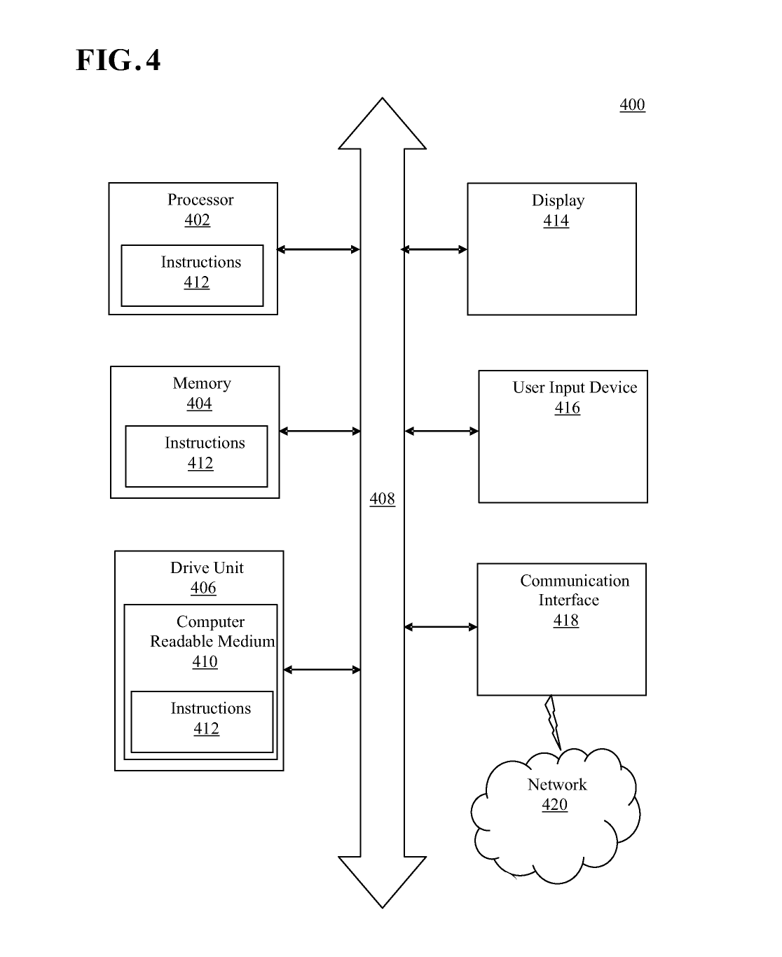

The exchange computer system 100 may be implemented with one or more mainframe, desktop or other computers, such as the computer 400 described below with respect to FIG. 4. A user database 102 may be provided which includes information identifying traders and other users of exchange computer system 100, such as account numbers or identifiers, user names and passwords. An account data module 104 may be provided which may process account information that may be used during trades. A match engine module 106 may be included to match bid and offer prices and may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. The risk management module 134 may also be configured to determine risk assessments or exposure levels in connection with positions held by a market participant. An order processing module 136 may be included to decompose delta based and bulk order types for processing by the order book module 110 and/or match engine module 106. A default management module 137 may be included to facilitate the implementation of an auction process in the event of a default, as well as the application of the contributions to the guaranty fund to cover any losses remaining after the auction. The default management module 137 may be configured to implement one or more aspects of the disclosed methods and systems, including, for instance, the apportionment of a guaranty fund contribution in accordance with the quality of the bids provided during the auction. The default management module 137 may be in communication with the risk management module 134 to receive data indicative of the risk assessments and/or exposure levels of the positions held by the market participants.

The trading network environment shown in FIG. 1 includes exemplary computer devices 114, 116, 118, 120 and 122, which depict different exemplary methods or media by which a computer device may be coupled with the exchange computer system 100 or by which a user may communicate, e.g. send and receive, trade or other information therewith. It will be appreciated that the types of computer devices deployed by traders and the methods and media by which they communicate with the exchange computer system 100 is implementation dependent and may vary and that not all of the depicted computer devices and/or means/media of communication may be used and that other computer devices and/or means/media of communications, now available or later developed may be used. Each computer device, which may comprise a computer 400 described in more detail below with respect to FIG. 4, may include a central processor that controls the overall operation of the computer and a system bus that connects the central processor to one or more conventional components, such as a network card or modem. Each computer device may also include a variety of interface units and drives for reading and writing data or files and communicating with other computer devices and with the exchange computer system 100. Depending on the type of computer device, a user can interact with the computer with a keyboard, pointing device, microphone, pen device or other input device now available or later developed.

An exemplary computer device 114 is shown directly connected to exchange computer system 100, such as via a T1 line, a common local area network (LAN) or other wired and/or wireless medium for connecting computer devices, such as the network 420 shown in FIG. 4 and described below with respect thereto. The exemplary computer device 114 is further shown connected to a radio 132. The user of radio 132, which may include a cellular telephone, smart phone, or other wireless proprietary and/or non-proprietary device, may be a trader or exchange employee. The radio user may transmit orders or other information to the exemplary computer device 114 or a user thereof. The user of the exemplary computer device 114, or the exemplary computer device 114 alone and/or autonomously, may then transmit the trade or other information to the exchange computer system 100.

Exemplary computer devices 116 and 118 are coupled with a local area network (“LAN”) 124 which may be configured in one or more of the well-known LAN topologies, e.g. star, daisy chain, etc., and may use a variety of different protocols, such as Ethernet, TCP/IP, etc. The exemplary computer devices 116 and 118 may communicate with each other and with other computer and other devices which are coupled with the LAN 124. Computer and other devices may be coupled with the LAN 124 via twisted pair wires, coaxial cable, fiber optics or other wired or wireless media. As shown in FIG. 1, an exemplary wireless personal digital assistant device (“PDA”) 122, such as a mobile telephone, tablet based compute device, or other wireless device, may communicate with the LAN 124 and/or the Internet 126 via radio waves, such as via WiFi, Bluetooth and/or a cellular telephone based data communications protocol. PDA 122 may also communicate with exchange computer system 100 via a conventional wireless hub 128.

FIG. 1 also shows the LAN 124 coupled with a wide area network (“WAN”) 126 which may be comprised of one or more public or private wired or wireless networks. In one embodiment, the WAN 126 includes the Internet 126. The LAN 124 may include a router to connect LAN 124 to the Internet 126. Exemplary computer device 120 is shown coupled directly to the Internet 126, such as via a modem, DSL line, satellite dish or any other device for connecting a computer device to the Internet 126 via a service provider therefore as is known. LAN 124 and/or WAN 126 may be the same as the network 420 shown in FIG. 4 and described below with respect thereto.

As described above, the users of the exchange computer system 100 may include one or more market makers or market participants, which may maintain a market by providing constant bid and offer prices for a derivative or security to the exchange computer system 100, such as via one of the exemplary computer devices depicted. The exchange computer system 100 may also exchange information with other trade engines, such as trade engine 138. Numerous additional computers and systems may be coupled to exchange computer system 100. Such computers and systems may include clearing, regulatory and fee systems.

The operations of computer devices and systems shown in FIG. 1 may be controlled by computer-executable instructions stored on a non-transitory computer-readable medium. For example, the exemplary computer device 116 may include computer-executable instructions for receiving order information from a user and transmitting that order information to exchange computer system 100. In another example, the exemplary computer device 118 may include computer-executable instructions for receiving market data from exchange computer system 100 and displaying that information to a user.

Numerous additional servers, computers, handheld devices, personal digital assistants, telephones and other devices may also be connected to the exchange computer system 100. Moreover, the topology shown in FIG. 1 is merely an example and that the components shown in FIG. 1 may include other components not shown and be connected by numerous alternative topologies.

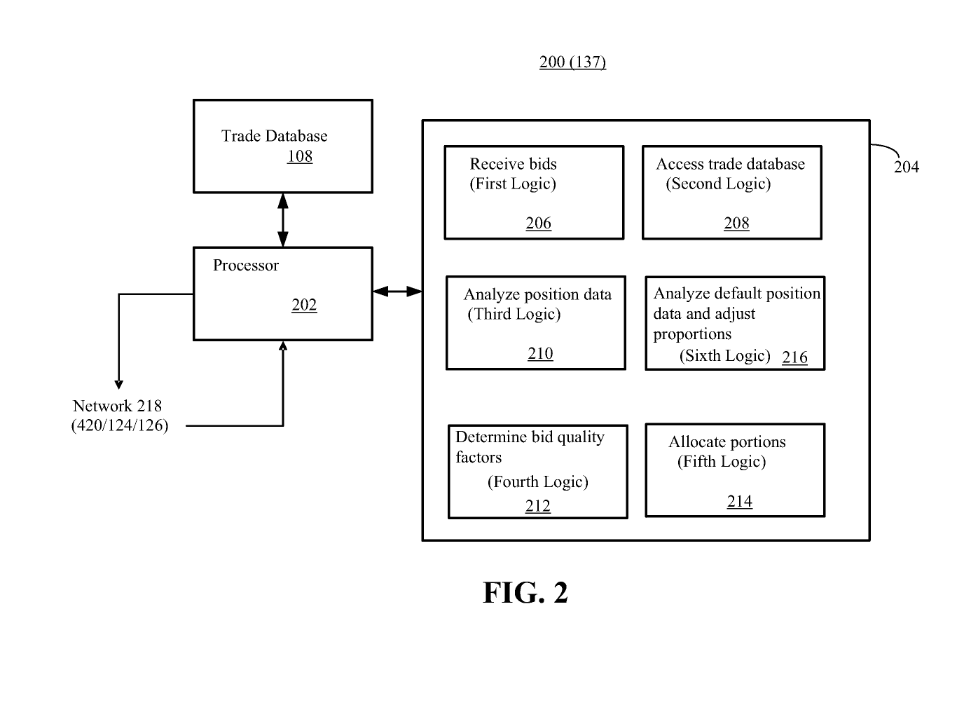

As shown in FIG. 1, the risk management module 134 and/or the default management module 137 of the Exchange computer system 100 may implement one or more aspects of the apportionment provided by the disclosed methods and systems, as will be described with reference to FIG. 2. It will be appreciated the disclosed embodiments may be implemented as a separate module or a separate computer system coupled with the Exchange computer system 100 so as to have access to the requisite portfolio data. As described above, the disclosed embodiments may be implemented as a centrally accessible system or as a distributed system where some of the disclosed functions are performed by the computer systems of the market participants.

FIG. 2 depicts a block diagram of a default management module 137 according to one embodiment, which in an exemplary implementation, is implemented as part of the exchange computer system 100 described above. As used herein, an exchange includes a place or system that receives and/or executes orders. FIG. 2 shows a system 200 for apportionment of a guaranty fund into tranches for prioritized application of the guaranty fund to a loss arising in connection with an auction. The guaranty fund includes respective contributions from a plurality of market participants in a set of markets, such as various IRS markets. The auction is directed to transferring open positions in the set of markets of a market participant in default. The positions are transferred to one or more market participants not in default.

The system 200 includes a processor 202 and a memory 204 coupled therewith which may be implemented as a processor 402 and memory 404 as described below with respect to FIG. 4. The system 200 further includes a first logic 206 stored in the memory 204 and executable by the processor 202 to cause the processor 202 to receive, such as via a network 218 coupled therewith, bids for the open positions from each market participant. A respective bid may be received from each market participant for each open position. The quality of each respective bid may then be used to allocate a portion of the guaranty fund contribution corresponding with the market of the open position for which the bid is provided. In an embodiment in which the open positions are in IRS markets, each bid is specified in a currency corresponding with the IRS market.

In some cases, market participants not having a position in a particular market are not obligated to provide a bid in the auction for the open position in that market. The system 200 may alternatively or additionally address the lack of a position through the risk assessment computations described below (e.g., the lack of a position leads to a risk assessment of zero in that market). In that way, a market participant may provide a bid for an open position in which the market participant holds no current position, but avoid the risk of a subordination penalty arising from such bid.

The system 200 further includes second logic 208 stored in the memory 204 and executable by the processor 202 to cause the processor 202 to access a trade database 108 (see also FIG. 1) or other memory(ies) in which position data is stored for the market participants. The position data may be indicative of the respective positions of the market participants in the set of markets. Position data for the non-default market participants and the defaulting market participant is thus available for use in apportioning the guaranty fund contributions. The processor 202 may be in communication with the trade database 108 or other memory(ies) via the network 218 or any other communication link.

The system 200 further includes third logic 210 stored in the memory 204 and executable by the processor 202 to cause the processor 202 to analyze the position data. The analysis is directed to determining, for each non-default market participant, a risk assessment proportion for each market of the non-default market participant. The risk assessment proportions may be determined relative to the overall risk presented by the positions held by the market participant. For example, in an IRS portfolio having IRS positions in U.S. dollars (USD), euros (EUR), Great Britain pounds (GBP), and Canadian dollars (CAD), the risk assessment analysis may determine that the breakdown of risk across the portfolio is 65% USD, 10% EUR, 20% GBP, and 5% CAD. These proportions may then be used to determine the portions of the guaranty fund contributions at risk of subordination or other prioritization. In some embodiments, the proportions correspond with initial allocation portions that may be modified in further processing. As described below, the further processing may adjust the allocation portions based on the exposure levels presented by the open positions.

The analysis implemented by the third logic 210 may include further logic or be otherwise further executable by the processor 202 to determine, for each non-default market participant, a stressed exposure level for each respective position of the non-default market participant. The stressed exposure level may then be used to determine the risk assessment proportions. The stressed exposure level is determined on a market-by-market basis by applying one or more stress tests to the positions held by the market participants. The stress test(s) may provide a potential loss value based on historical or other data (e.g., market simulation data) to simulate a worst-case or other scenarios. Any number or type of stress tests may be applied. The range of the historical data may vary. The resulting potential loss value may correspond with a certain percentile (e.g., a loss worse than 99.7% of the possible scenarios evaluated by the stress test). A shortfall value for each market may then be computed by subtracting from the amount of the performance bond posted by the market participant from the potential loss value. The risk assessment proportions may then correspond with the proportion presented by the shortfall for each market relative to the total shortfall for the market participant across all of the markets for which the auction is held.

The system further includes fourth logic 212 stored in the memory 204 and executable by the processor 202 to cause the processor 202 to determine a quality factor for each bid received from the auction participants. The fourth logic 212 determines the quality factor for each bid based on an offset between the respective bid and a winning bid in the auction. A higher offset is indicative of a less competitive bid. The offset may be determined by calculating the difference between the bid and the winning bid. The manner in which the offset is expressed may vary.

In some embodiments, the offset may then be processed to scale the quality factor in accordance with the open position. Such scaling may provide an indication of the extent to which the competitiveness of the received bid may be compared across currencies or markets. For example, the fourth logic 212 may be further executable by the processor 202 to cause the processor 202 to compute a ratio between the offset and an exposure margin for the open position. Both the offset and the exposure margin are specified in the same currency. In IRS examples, for instance, the bids are expressed in the same currency as the open position being auctioned. The exposure margin, or initial margin, may be based on the difference between a potential loss determined via one or more stress tests and a performance bond posted by the market participant in default. The quality factor may then be derived from a ratio of the offset and the exposure margin. This scaled quality factor is referred to herein as the “erosion” of the received bid relative to the winning bid. A lower erosion is thus indicative of a competitive bid, while a higher erosion is indicative of a non-competitive bid.

The system 200 further includes fifth logic 214 stored in the memory 204 and executable by the processor 202 to cause the processor 202 to allocate, for each market and for each non-default market participant, a portion of the guaranty fund contribution of the non-default market participant to one of the tranches based on the erosion or other quality factor determined for the market. The portion is defined in accordance with the risk assessment proportion for that market. The erosion or other quality factor determines the tranche, and may also be used to adjust the size of the portion, as described below.

The number of tranches may vary. In one embodiment, the system 200 allocates the portions across three tranches, a higher or senior tranche, a lower or junior tranche, and an intermediate tranche between the senior and junior tranches. The fifth logic 214 is then further executable by the processor 202 to cause the processor 202 to assign a portion to a junior tranche if the quality factor exceeds a first threshold. In the erosion or other scaled embodiment, the first threshold may be expressed as a percentage (e.g., 90% or 100%). The threshold may vary. Each portion associated with a winning bid may be assigned to the senior tranche by the processor 202 via the fifth logic 214. A winning bid may also be processed by the system 200 as a bid with a quality factor of zero (due to the lack of an offset between the received bid and the winning bid). The quality factor may be indicative of the winning bid in other ways. The fifth logic 214 is then further executable by the processor 202 to cause the processor 202 to assign a portion to the intermediate tranche if the quality factor is below a second threshold, such as 50%.

In some three-tranche embodiments, the first and second thresholds may be the same. In other embodiments, the first and second thresholds are spaced from one another to define a range in which a partial subordination penalty results from the bid. In such cases, the portion of the guaranty fund contribution allocated to the lower tranche is modified to reflect the partial penalty. The fifth logic 214 may be further executable by the processor 202 to cause the processor 202 to reduce the portion linearly in accordance with a position of the quality factor between the first and second thresholds. The reduced portion may then be assigned to the junior tranche, with the reminder staying in the intermediate tranche.

The embodiment of FIG. 2 is configured to adjust the foregoing apportionment process to reflect the exposure levels presented by the open positions being auctioned. The system 200 may thus encourage the auction participants to submit competitive bids in auctions in which the participant has a substantial position (or risk of loss) and in which the defaulting participant has a substantial position (or risk of loss). In this example, the system 200 further includes sixth logic 216 stored in the memory 204 and executable by the processor 202 to cause the processor 202 to analyze the position data in the trade database 108 (or other memory) to determine, for each open position of the market participant in default, a default exposure proportion for each market, and then adjust, for each market and each non-default market participant, the risk assessment proportion for the non-default market participant if the default exposure proportion is greater than the risk assessment proportion. For example, if the auction participant has risk assessment proportions of 65% USD, 10% EUR, 20% GBP, and 5% CAD based the positions of the auction participant, but the exposure proportions of the default portfolio are 35% USD, 40% EUR, 10% GBP, and 10% CAD, then adjustments are warranted for the risk assessment proportions for the euro market and the Canadian dollar market. The adjusted risk assessment proportions are thus 65% USD, 40% EUR, 20% GBP, and 10% CAD. The sixth logic 216 may then be further executable by the processor 202 to cause the processor 202 to normalize the risk assessment proportions for each non-default market participant so that the total allocation does not exceed 100% of the guaranty fund contribution of the market participant.

The system 200 may be further configured to determine an aggregate value for each tranche to facilitate the application of the funds in each tranche to the losses remaining after the auction. In the three-tranche example described above, the portions of the guaranty fund contributions allocated to the junior tranche are applied first in pro rata fashion across the auction participants until the funds in the tranche are exhausted. If necessary, the portions allocated to the intermediate tranche are applied next in similar fashion, followed by the portions in the senior tranche.

Data indicative of any the intermediate or final results of the above-described processing may be stored in the trade database 108, the memory 204, or other database or memory of the system 200 or the exchange computer system 100 (FIG. 1). Data indicative of the portions allocated to the respective tranches may be transferred to the market participants via the network 218 or any of the other communications links described herein.

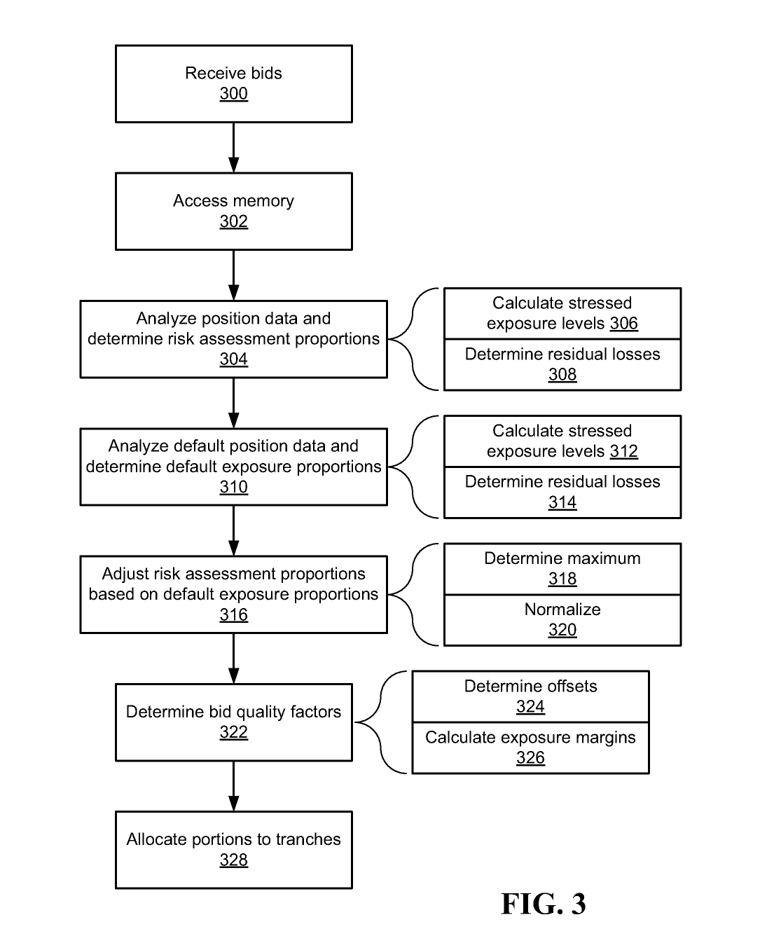

FIG. 3 depicts a flow chart showing operation of the system 200 of FIG. 2. In particular FIG. 3 shows a computer implemented method for apportionment of a guaranty fund into tranches for prioritized application of the guaranty fund to a loss arising in connection with an auction. The guaranty fund includes respective contributions from a plurality of market participants in a set of markets, and the auction is directed to transferring open positions of a defaulting market participant to the auction participants. The operation of the system 200 includes: receiving bids for the open positions from each non-default market participant [block 300], accessing a memory in which position data indicative of respective positions of the non-default market participants in the set of markets is stored [302]; and analyzing the position data, with a processor, to determine, for each non-default market participant, a risk assessment proportion for each market of the non-default market participant [block 304]. The analysis may include calculating or otherwise determining, with the processor, for each non-default market participant, a stressed exposure level for each respective position of the non-default market participant [block 306] and determining residual losses by, for instance, subtracting the value of a performance bond from the stressed exposure level [block 308].

In some embodiments, the operation of the system 200 further includes analyzing the position data, with the processor, to determine, for each open position of the market participant in default, a default exposure proportion for each market of the market participant in default [block 310]. The analysis may include calculate the stressed exposure levels [block 312] and determine any potential residual loss [block 314]. The operation of the system 200 may then further include adjusting, for each market and each non-default market participant, the risk assessment proportion for the non-default market participant [block 316]. The adjustment may include determining whether the default exposure proportion is greater than the risk assessment proportion [block 318]. The risk assessment proportions for each non-default market participant may then be normalized [block 320].

The operation of the system 200 further includes determining, with the processor, a quality factor for each bid based on an offset between the bid and a winning bid in the auction for each open position [blocks 322, 324]. In some embodiments, the determination includes computing, with the processor, an exposure margin for the open position based on a stress test loss and a performance bond posted by the market participant in default for the open position [block 326]. The quality factor may then be derived from a ratio of the offset and the exposure margin.

The operation of the system 200 further includes allocating, for each market and for each non-default market participant, a portion of the guaranty fund contribution of the non-default market participant to one of the tranches based on the quality factor for the market [block 328]. The portion is defined in accordance with the risk assessment proportion for the market. In one embodiment, the allocation includes assigning the portion to a junior tranche if the quality factor exceeds a first threshold, assigning the portion to a senior tranche for each winning bid, and assigning the portion to an intermediate tranche between the junior and senior tranches if the quality factor is below a second threshold. The portion may be reduced linearly in accordance with a position of the quality factor between the first and second thresholds. The reduced portion may then be assigned to the junior tranche.

The blocks of the above-described method may be implemented in an order other than as shown. For example, the risk assessment proportions, either with or without adjustment to reflect the open positions, may be determined before the bids are received. The implementation of the blocks may involve one or more nested, recursive, or iterative procedures to, for instance, address each market, market participant, etc., respectively, before aggregation of the allocated portions in the tranches. The processing order may vary in accordance with the configuration of such procedures. Additional or alternative blocks may be implemented.

One or more modules described herein may be implemented using, among other things, a tangible computer-readable medium comprising computer-executable instructions (e.g., executable software code). Alternatively, modules may be implemented as software code, firmware code, hardware, and/or a combination of the aforementioned. For example the modules may be embodied as part of an exchange system 100 for financial instruments.

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above, such as the processor 202, may be a computer system 400 or a component in the computer system 400. The computer system 400 may implement a match engine, margin processing, payment or clearing function on behalf of an exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include a disk or optical drive unit 406. The disk drive unit 406 may include a computer-readable medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

As described above, one or more aspects of the methods and systems may be configured to incentivize bidding by clearing members in a competitive auction held by the clearing house after a default event. In the event of a default by a clearing member, the auction is directed to transferring the open customer positions of the defaulting clearing member. The clearing house may first attempt to hedge the positions, and then auction any hedged and unhedged positions to other clearing members. As described above, the disclosed methods and systems are configured to reward winning auction bids by allocating a portion of the winning clearing firm's contribution to the guaranty fund to a higher tranche, and penalizes a non-competitive bid by subordinating a portion of the clearing firm's contribution to a lower tranche.

Implementation of the disclosed methods and systems is not limited to applications in which an actual auction is occurring. The auction may be a simulated auction. For example, the apportionment process may be simulated to show “what if” results according to various combinations of bids and/or positions. The results may be provided to a market participant as feedback in preparation for an actual auction. The above-described processing systems may be useful for executing large number of such simulated auctions to provide market participants with data or information leading up to, or during, the actual auction. The market participants may use such information to predetermine or otherwise prepare bids for the open positions.

FIG. 5 provides an exemplary implementation of one embodiment of the disclosed methods and systems. The incentivized auction process may be illustrated with an example portfolio of multicurrency IRS positions. For non-defaulting clearing members having portfolios comprised of various positions in USD, EUR, GBP, and CAD, the portion of the clearing members' guaranty fund contribution associated with the currency that received a non-qualifying bid is allocated or subordinated to a lower tranche. The portion associated with a winning bid is allocated to a higher tranche, or seniorized. Losses that hit the guaranty fund are satisfied first by the subordinated portions first. Non-subordinated guaranty fund contributions remain untouched until the subordinated portions are exhausted.

As shown in FIG. 5, to determine the subordinated portions, the risk allocation proportions for each clearing member or firm are determined on a currency-by-currency basis. The proportions are determined for each firm by calculating a shortfall in each currency. The currency-specific shortfall determinations are calculated by stressing and margining each currency, assuming no interaction or correlation between currencies. The shortfall for each currency may then be expressed as a percentage (or other proportion) of the sum of all currency-specific shortfalls for a given clearing member or firm. For example, with a total shortfall of $1,000,000, member A has the following risk allocation proportions: USD 60%, EUR 5%, GBP 5%, and CAD 30%. The risk allocations proportions are indicative of the amount at risk of subordination for any given firm, which is indicated by the potential juniorization allocations (PJA) for each member, and are shown in the table entitled “PJA.”

The risk allocation proportions are then adjusted based on the exposure level proportions of the defaulting firm. In this example, for each non-defaulting firm with open interest in a currency, the potential subordination allocation is calculated as the maximum of its shortfall allocations and the defaulted firm's shortfall allocation per currency. In the example shown in FIG. 5, the portfolio of member B presents minimal proportional risk in USD (5%), but the exposure level in USD in the defaulted portfolio increases the proportion to 60%. In other embodiments, the adjustment need not involve setting the proportion equal to the maximum of the two proportions for each currency. Other adjustment techniques may be used.

In this example, firms with zero open interest in a currency are not subject to apportioning in that currency, regardless of the exposure level of the defaulted member. The risk allocation proportion for such currencies thus remains 0%, as shown in the risk allocation proportion in CAD for member A. In other embodiments, the risk allocation proportion may be adjusted in such cases as well to reflect the exposure level of the defaulted firm.

After the adjustments, the proportions are normalized so that the total risk assessment for each member equals 100%, as shown in the table entitled “Normalized PJA.” Normalization ensures that at most 100% of the guaranty fund contribution of a member is at risk of subordination.

The bid quality, or erosion, factors are set forth in the table entitled “Bid Results.” The erosion values are determined from the ratio of the bid offset (e.g., the offset between the respective bid and the winning bid in each market as described above) to the initial or exposure margin of the open position. Each erosion value may be expressed as a percentage. For example, the erosion level of the bid from member A for the open USD position is 25%.

The erosion levels for the non-winning bids are evaluated to determine the apportionment. In this example, two thresholds are applied to determine which bids are penalized and/or to what extent bids are penalized. For erosion levels of 100% and higher (Category 2 erosion), the entire portion of the guaranty fund contribution is subordinated to a junior tranche. For example, the GBP bid from member B resulted in an erosion level of 105% and, as a result, the entire normalized proportion of the guaranty fund contribution for the GBP market (3%) is allocated to the junior tranche.

For erosion levels between 50% and 100% (Category 1 erosion), a weighted portion of the guaranty fund contribution is subordinated. The size of the portion is scaled in accordance with the erosion level. For example, the USD bid from member B resulted in an erosion level of 60%. The size of the allocation to the junior tranche is linearly adjusted with the erosion level. The linear adjustment may be determined by calculating an erosion penalty as follows: (erosion level−50%)*2. In this example, the erosion penalty is 0.2 (i.e., 60−50%)*2. As a result, only one-fifth of the portion of the guaranty fund contribution at risk of subordination is allocated to the junior tranche. In this example, one-fifth of 39% (or 7.8%) of the contribution is subordinated. This embodiment provides only one example of how the thresholds may be used to determine the subordination percentage via an erosion penalty.

In this example, erosion levels below 50% result in allocation to the intermediate tranche between the junior and senior tranche.

Data indicative of a winning bid may be stored in various ways, including, for example, as an erosion level of 0. The normalized proportion of the guaranty fund contribution for each winning bid is allocated to the senior tranche. For example, the EUR bid from member A results in the allocation of 10% of member A's guaranty fund contribution to the senior tranche.

The allocations to each tranche are shown in the final table of FIG. 5. The allocations to each tranche may then be aggregated for application to any loss remaining after the auction. The funds allocated to the junior tranche are applied first pro rata. The funds in the higher tranches are only applied if the funds in the lower levels are exhausted.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

What is claimed is:

1. A computer implemented method for apportionment of a guaranty fund into tranches for prioritized application of the guaranty fund to a loss arising in connection with an auction, the guaranty fund comprising respective contributions from a plurality of market participants in a set of markets, the auction being directed to transferring open positions in the set of markets of a respective one of the plurality of market participants in default to one or more non-default market participants of the plurality of market participants, the method comprising:
receiving bids for the open positions from each non-default market participant;
determining, with a processor, a quality factor for each bid based on an offset between the bid and a winning bid in the auction for each open position; and
allocating, for each market and for each non-default market participant, a portion of the guaranty fund contribution of the non-default market participant to one of the tranches based on the quality factor for the market.

2. The computer implemented method of claim 1 further comprising determining, for each non-default market participant, a risk assessment proportion for each market of the non-default market participant, wherein:
allocating the portion comprises defining the portion in accordance with the risk assessment proportion for the market; and
determining the risk assessment proportion comprises determining for each non-default market participant, a stressed exposure level for each respective position of the non-default market participant.

3. The computer implemented method of claim 1 further comprising:
analyzing the position data, with the processor, to determine, for each open position of the market participant in default, a default exposure proportion for each market of the market participant in default; and
adjusting, for each market and each non-default market participant, the risk assessment proportion for the non-default market participant if the default exposure proportion is greater than the risk assessment proportion.

4. The computer implemented method of claim 3 wherein adjusting the risk assessment proportion comprises normalizing the risk assessment proportions for each non-default market participant.

5. The computer implemented method of claim 1 wherein determining the quality factor for each bid comprises:
computing, with the processor, an exposure margin for the open position based on a stress test loss and a performance bond posted by the market participant in default for the open position; and
deriving the quality factor from a ratio of the offset and the exposure margin.

6. The computer implemented method of claim 1 wherein allocating the portion of the guaranty fund contribution comprises:
assigning the portion to a junior tranche if the quality factor exceeds a first threshold;
assigning the portion to a senior tranche for each winning bid; and
assigning the portion to an intermediate tranche between the junior and senior tranches if the quality factor is below a second threshold.

7. The computer implemented method of claim 6 wherein allocating the portion of the guaranty fund contribution comprises:
reducing the portion linearly in accordance with a position of the quality factor between the first and second thresholds; and
assigning the reduced portion to the junior tranche.

8. The computer implemented method of claim 1 wherein at least one market of the set of markets is an interest rate swap market.

9. The computer implemented method of claim 8 wherein:
each bid is specified in a currency corresponding with the interest rate swap market; and
determining the quality factor for each bid comprises computing a ratio between the offset and an exposure margin for the open position specified in the currency.

10. A system for apportionment of a guaranty fund into tranches for prioritized application of the guaranty fund to a loss arising in connection with an auction, the guaranty fund comprising respective contributions from a plurality of market participants in a set of markets, the auction being directed to transferring open positions in the set of markets of a respective one of the plurality of market participants in default to one or more non-default market participants of the plurality of market participants, the system comprising a processor and a memory coupled therewith, the system further comprising:
receive logic stored in the memory and executable by the processor to cause the processor to receive bids for the open positions from each non-default market participant;
quality factor logic stored in the memory and executable by the processor to cause the processor to determine a quality factor for each bid based on an offset between the bid and a winning bid in the auction for each open position; and
allocation logic stored in the memory and executable by the processor to cause the processor to allocate, for each market and for each non-default market participant, a portion of the guaranty fund contribution of the non-default market participant to one of the tranches based on the quality factor for the market, the portion being defined in accordance with the risk assessment proportion for the market.

11. The system of claim 10 further comprising risk assessment logic executable by the processor to cause the processor to determine, for each non-default market participant, a risk assessment proportion for each market of the non-default market participant, wherein:
the allocation logic is further executable by the processor to cause the processor to define the portion in accordance with the risk assessment proportion for the market; and
the risk assessment logic is further executable by the processor to cause the processor to determine, for each non-default market participant, a stressed exposure level for each respective position of the non-default market participant.

12. The system of claim 10 further comprising sixth logic stored in the memory and executable by the processor to cause the processor to:
analyze the position data to determine, for each open position of the market participant in default, a default exposure proportion for each market of the market participant in default; and
adjust, for each market and each non-default market participant, the risk assessment proportion for the non-default market participant if the default exposure proportion is greater than the risk assessment proportion.

13. The system of claim 12 wherein the sixth logic is further executable by the processor to cause the processor to normalize the risk assessment proportions for each non-default market participant.

14. The system of claim 10 wherein the fourth logic is further executable by the processor to cause the processor to compute, with the processor, an exposure margin for the open position based on a stress test loss and a performance bond posted by the market participant in default for the open position and to derive the quality factor from a ratio of the offset and the exposure margin.

15. The system of claim 10 wherein the fifth logic is further executable by the processor to cause the processor to assign the portion to a junior tranche if the quality factor exceeds a first threshold, to assign the portion to a senior tranche for each winning bid, and to assign the portion to an intermediate tranche between the junior and senior tranches if the quality factor is below a second threshold.

16. The system of claim 15 wherein the fifth logic is further executable by the processor to cause the processor to reduce the portion linearly in accordance with a position of the quality factor between the first and second thresholds and to assign the reduced portion to the junior tranche.

17. The system of claim 10 wherein at least one market of the set of markets is an interest rate swap market.

18. The system of claim 17 wherein each bid is specified in a currency corresponding with the interest rate swap market and wherein the fourth logic is further executable by the processor to cause the processor to compute a ratio between the offset and an exposure margin for the open position specified in the currency.

19. A system for apportionment of a guaranty fund into tranches for prioritized application of the guaranty fund to a loss arising in connection with an auction, the guaranty fund comprising respective contributions from a plurality of market participants in a set of markets, the auction being directed to transferring open positions in the set of markets of a respective one of the plurality of market participants in default to one or more non-default market participants of the plurality of market participants, the system comprising:
means for receiving bids for the open positions from each non-default market participant;
means for determining a quality factor for each bid based on an offset between the bid and a winning bid in the auction for each open position; and
means for allocating, for each market and for each non-default market participant, a portion of the guaranty fund contribution of the non-default market participant to one of the tranches based on the quality factor for the market.

20. The system of claim 19 further comprising means for analyzing the position data to determine, for each non-default market participant, a risk assessment proportion for each market of the non-default market participant,
wherein means for allocating comprises means for defining the portion in accordance with the risk assessment proportion for the market;
wherein means for analyzing the position comprises means for determining, for each non-default market participant, a stressed exposure level for each respective position of the non-default market participant; and
wherein the system further comprises:
means for analyzing the position data to determine, for each open position of the market participant in default, a default exposure proportion for each market of the market participant in default; and
means for adjusting, for each market and each non-default market participant, the risk assessment proportion for the non-default market participant if the default exposure proportion is greater than the risk assessment proportion, wherein means for adjusting the risk assessment proportion comprises means for normalizing the risk assessment proportions for each non-default market participant.
